(19) United States
(12) Patent Application Publication
(10) Pub. No.: US 2012/0298861 A1
(43) Pub. Date: Nov. 29, 2012

(54) Vector Potential Photoelectron Microscope

(76) Inventor: Raymond Browning, Shoreham, NY (US)

(21) Appl. No.: 13/113,770

(22) Filed: May 23, 2011

(51) Int. Cl. H01J 40/00; G01T 1/20; G01T 1/16

(52) U.S. Cl. 250/305; 250/393; 250/395; 250/362; 250/363.01

(57) ABSTRACT

A photoelectron microscope uses the vector potential field as a spatial reference. The microscope can be used with a source of photons to image surface chemistry.

### STATEMENT REGARDING FEDERALLY SPONSORED RESEARCH OR DEVELOPMENT

This invention was made with Government support under SB134107CN0042, SB134109CN0082, and SB134110CN0065 awarded by the National Institute of Standards and Technology. The Government has certain rights in the invention.

### TECHNICAL FIELD

The present invention relates generally to electron microscopy, and more particularly to photoelectron microscopy.

### BACKGROUND INFORMATION AND DISCUSSION OF RELATED ART

Photoelectron microscopy (PEM) is an important tool in materials science. PEM is used in many ways, and there is a vast literature on it. PEM is used for understanding the chemistry of a surface such as in catalysis, the microanalysis of magnetic states such as in thin film read/write heads, the analysis of electronic band structures, the structure of organic films, and the coordination of atoms at a surface among many other uses.

There is also a wide variety of PEM instrument types. These instruments include micro focused scanning x-ray probes of multiple types, electrostatic lens microscopes, and magnetic lens microscopes which cover a wide range of incident photon energies from a few electron volts up to several kilovolts, and a wide range of analysis techniques.

To investigate most materials systems there is no one technique or instrument that covers all the materials properties. Thus many specialized instruments are built to study one aspect of a problem, and then this information is combined with many other pieces of information to form a model of the system. There is always room for a new microscopic technique that opens up the possibilities of novel experiments.

While there are numerous types of PEM in the literature with a substantial body of patented art, no art exists that suggest that the magnetic vector potential field, also known as the vector potential field, can be used in photoelectron microscopy.

The magnetic vector potential field is the basis of electromagnetic theory, and unifies both the magnetic, and electric fields. Maxwell's equations describing electromagnetic light and radio waves were written in terms of the magnetic vector potential field. The magnetic field B equals the curl of the magnetic vector potential field A.

B=∇×A (1)

The electric field E is equal to the gradient of the scalar potential, and the change of the vector potential over time.

E=−∇Ø−≢A/≢t (2)

The vector potential field is a momentum field with dimensions of momentum per unit charge.

The vector potential field has been used explicitly in microscopy. Kuniaki Nagayama U.S. Pat. No. 7,851,757 teaches that the vector potential from a magnetic wire can be used to create a phase plate for holography. However, there is no prior art that uses the vector potential field in photoelectron microscopy.

Therefore, what is required to extend the art of photoelectron microscopy to new experimental possibilities is the use of the magnetic vector potential field.

### SUMMARY OF THE INVENTION

It is an object of the invention to provide a method and an instrument utilizing the properties of the vector potential field for photoelectron microscopy. Accordingly the invention is characterized by, a means to create photoelectrons, a means to create a vector potential field as a spatial reference for said photoelectrons emitted from a sample surface, and a means to image said photoelectrons. More specifically a photoelectron imaging apparatus comprising; a vector potential field of substantially uniform curl for producing a spatial reference, a sample immersed in said vector potential field, a source of photons for illuminating said sample and producing photoelectrons, an substantially electron transparent field reducing means for substantially reducing the magnitude of said vector potential field over a substantially short distance, and permitting the exit of said photoelectrons from said vector potential field, providing an imaging means to image said photoelectrons, whereby an image is formed by said photoelectrons emitted from said sample surface.

These and other aspects and benefits of the invention will become more apparent upon analysis of the drawings, specification and claims.

### BRIEF DESCRIPTION OF THE SEVERAL VIEWS OF THE DRAWINGS

The invention will be better understood and the objects and advantages of the present invention will become apparent when consideration is given to the following detailed description thereof. Such description makes reference to the annexed drawings wherein:

FIG. 1 is a schematic illustrating the parts of vector potential microscope;

FIG. 2 is a schematic illustrating the vector potential field at the center of a solenoid;

FIG. 3 is a schematic diagram of a first embodiment of a vector potential microscope comprising a ferromagnet;

FIG. 4 is a plot of electron trajectories calculated for a vector potential microscope;

FIG. 5 is a schematic diagram of an embodiment of a vector potential microscope including an ambient pressure cell:

FIG. 6 is a schematic diagram of a second embodiment of a vector potential microscope comprising a current carrying solenoid;

FIG. 7 is a schematic diagram of a third embodiment of a vector potential microscope comprising a concave image detector.

FIG. 8 is a schematic diagram of a fourth embodiment of a vector potential microscope comprising a concentric hemispherical detector.

### DETAILED DESCRIPTION OF THE INVENTION

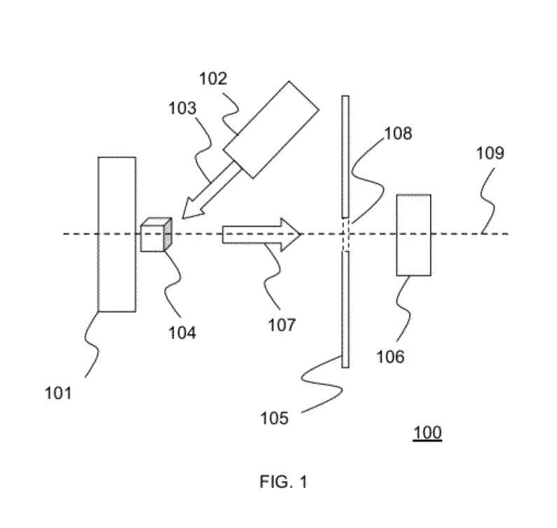

Referring to FIG. 1 through 8, wherein like reference numerals refer to like components in the various views, there is illustrated therein a new and improved photoelectron microscope.

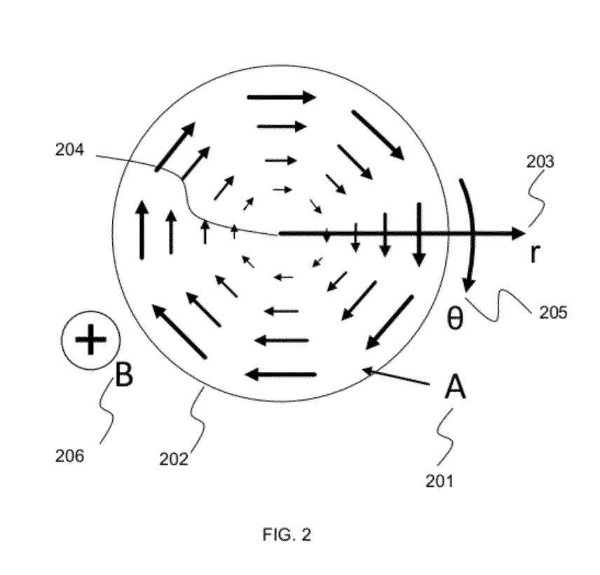

The invention described herein is contained in several functional elements and sub-elements individually and combined together to form the elements of a vector potential photoelectron microscope. FIG. 1 illustrates the hierarchy, linkages, and general functionality of the elements of the vector potential photoelectron microscope 100. The first element is a generating means 101 to create a vector potential field A 201 illustrated in FIG. 2. The second element is a source of photons 102, producing a photon beam 103 incident on the surface of a sample 104. The third element is a field reducing means 105 acting to substantially reduce the magnitude of the of the vector potential field A 201 within a short distance.

The fourth element is an electron imaging means 106 to image the beam of photoelectrons 107 emitted from the sample 104. The generating means 101 used to create a vector potential field A 201 is a system of moving, or rotating charges. These generating means 101 could include an arrangement of ferromagnetic parts, current carrying elements such as a solenoid, or a combination of such parts and elements. The field reducing means 105 will be substantially transparent to the beam of photoelectrons 107 allowing the electrons to reach the electron imaging means 106. The field reducing means 105 thus permits the exit of the beam of photoelectrons 107 from the vector potential field A 201. The substantially electron transparent field reducing means 105 could be a grid, or a plate with an aperture 108, or a second vector field generating means, or a combination of such elements. The electron imaging means 106 can be a grid with a phosphor plate, an electron sensitive semiconductor array, a multichannel plate with a phosphor, an arrangement of electron lenses and a electron position detector, an energy analyzing imaging spectrometer, or a combination of these and other elements.

The vector potential microscope 100 uses the vector potential field A 201 as a spatial reference for photoelectron. The vector field generating means 101 creates a vector potential field A 201 substantially on the optical axis 109 of the vector potential microscope 100. It is useful to the operation of the vector potential microscope 100 that the vector potential field A 201 has a vector curl that is constant over the volume of the surface of the sample 104 to be imaged. The curl of the vector potential field A 201 is defined as ∇×A. A substantially constant curl can be achieved by either placing the sample at the center of a solenoid or near the pole piece of a ferromagnet. A vector potential field A 201 with a constant curl is illustrated in FIG. 2. The field of rotating arrows 202 indicate the direction, and magnitude of the vector potential field. The magnitude of the vector potential field A 201 increases linearly with the radius 203 from the center 204 of the field of rotating arrows 202. The vector potential field A 201 at any position has an direction 205 around the center 204. The sample 104 is placed within the vector potential field A 201 such that as photoelectrons are emitted from the sample 104 surface then the photoelectrons have a potential momentum due to their position within the vector potential field A 201. Thus photoelectrons in the beam of photoelectrons 107 have different potential momenta depending on their position of emission from the sample 104 surface. The potential momenta are distributed in the two dimensions of angle and magnitude. In effect a latent image is formed that is related to the dimensions of direction 205 and radius 203. The vector potential field is used for a spatial reference. A vector potential field A 201 with constant curl implies there is a constant magnetic field B 206 across the sample 104. The potential momenta of the photoelectrons only becomes apparent when the vector potential field A 201 is effectively terminated by the field reducing means 105. As the vector potential field A 200 is suddenly reduced by the field reducing means 105 the beam of photoelectrons 107 diverges as the photoelectrons gain kinetic momentum proportional to the magnitude, and in the direction of the vector potential field A 200 at the sample 104. The sudden field reduction creates an angular image in two angular dimensions that has as its spatial reference the vector potential field A 200 in the two dimensions of direction 205 and radius 203 at the sample 104 surface. The resultant angular image is the electron optical equivalent to a photon optical image of an area of a star field. This type of image can be imaged by a variety of image detectors 106. For example, the image can projected onto an image plane using an objective lens, or it can be directly captured on to a curved or plane detector by using the aperture 108 in the same manner as in a pinhole camera. Using an electron lens the image can also be converged into an imaging spectrometer, and the photoelectron image can be energy analyzed.

The vector potential field A 200 from a solenoid is gauge invariant, and the center 204 can be defined arbitrarily by the addition of a constant. Because of gauge invariance, the optical axis 109 of the vector potential microscope 100 can be defined independently of the actual positioning of the field generating means 101.

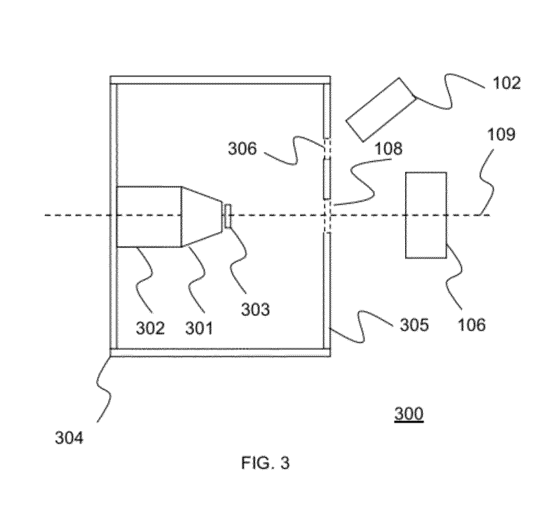

FIG. 3 illustrates a first embodiment of the invention. The fixed field strength vector potential microscope 300 is substantially rotationally symmetric along the optic axis 109. A ferromagnetic assembly 301 composed of ferromagnetic parts including a magnet 302 is utilized as a field generator 101. A specimen 303 is placed directly in front of the ferromagnetic assembly 301 on the optic axis 109 so that the vector potential field A 200 is both at its strongest, and has approximately constant curl across the specimen. A ferromagnetic enclosure 304 surrounds the ferromagnetic assembly 301. The front face 305 of the ferromagnetic enclosure 304 acts as a field reducer 105 along the optic axis 109. The front face 305 has an aperture 108 on the optic axis 109 so that photoelectrons can reach the image detector 106. A source of photoelectrons 102 illuminates the specimen 303 though a second aperture 306 in the ferromagnetic enclosure 304.

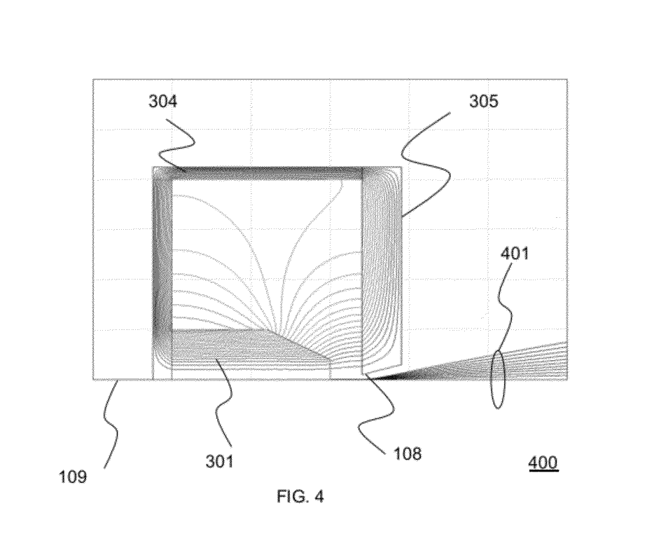

FIG. 4 is a plot 400 of theoretical electron trajectories 401 for the fixed field strength vector potential microscope 300. The ferromagnetic assembly 301 was modeled as a rare earth magnetic material magnetized along the optical axis 109. The software used to generate this plot 400 was the TriComp suite from Field Precision Corporation. The plot 400 is rotationally symmetric around the optic axis 109. The position of the specimen 303 is assumed to be at the beginning of the electron trajectories 401 and the detector 106 is at the end of the trajectories. The theoretical electron trajectories 401 simulate a photoelectron beam 107 leaving the specimen 303 surface. As the photoelectron beam 107 reaches the aperture 108 in the front face 305 the sudden change in the vector potential field A 200 imparts kinetic momentum to the photoelectrons. The amount and direction of the kinetic momentum depends on the initial position of the trajectory at the specimen 303. As can be seen from FIG. 4 the theoretical electron trajectories 401 diverge at the position of the aperture 108. The angle of divergence of individual electron trajectories 401 forms an angular image of the photoelectron intensity distribution at the specimen 303. It is important to note that while the electron trajectories 401 are within the vector potential field A 200 they form an approximately parallel beam that diverges slightly as the vector potential field A 200 becomes weaker moving away from the end of the ferromagnetic assembly 301. Until the aperture 108 is reached the electron trajectories 401 are constrained to a forward direction by the vector potential field A 200.

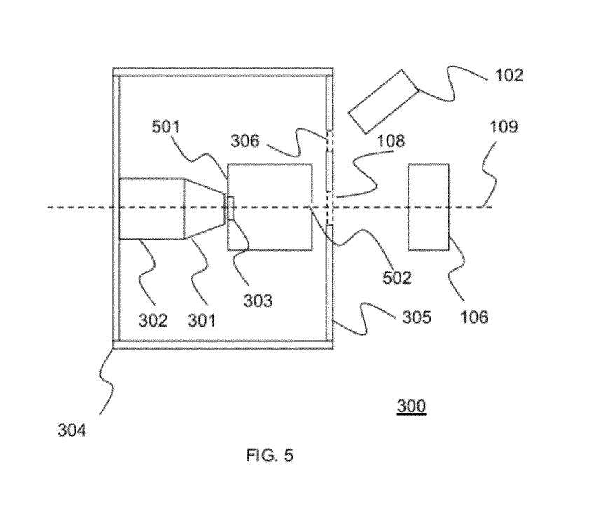

FIG. 5 illustrates the use of this constraint of the electron trajectories 401 to a forward direction. In FIG. 5 the interior of the fixed field strength vector potential microscope 300 contains an ambient pressure reaction cell 501. Photoelectrons that contain information about surface chemical reactions in the cell can leave the cell though a limited aperture 502. The leak rate of the ambient pressure cell through the limited aperture 502 can be low, and a reactant pressure established in the ambient pressure reaction cell 501.

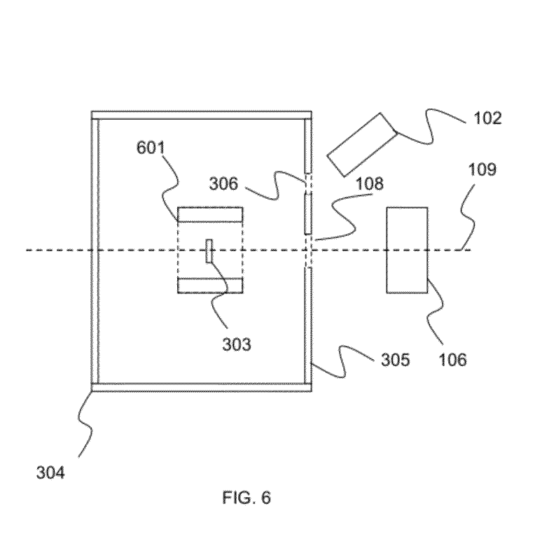

A second embodiment of the vector potential microscope 100 is illustrated in FIG. 6. This second embodiment uses a current carrying solenoid coil 601 to create the vector potential field A 200 as an alternative to the ferromagnetic assembly 301 used in FIG. 4. The specimen 303 is placed at the approximate center of the solenoid 601.

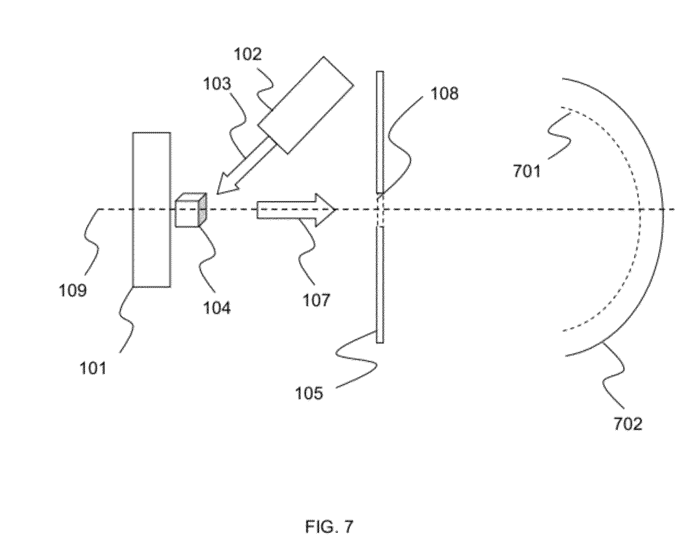

A third embodiment of the vector potential microscope 100 is illustrated in FIG. 7. The aperture 108 acts as a pinhole lens. A detector comprising a concave grid 701 and a concave phosphor 702 detects electrons of a high energy by retarding the photoelectrons with the first grid 701, and subsequently accelerating the high energy photoelectrons onto the phosphor 701 for imaging by a camera.

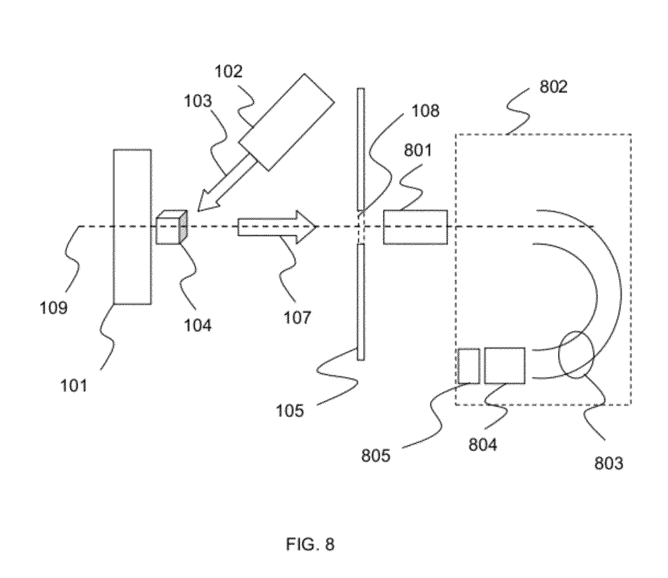

A fourth embodiment of the vector potential microscope 100 is illustrated in FIG. 8. A converging electron lens 801 converges the diverging photoelectrons into an imaging electron spectrometer 802. The imaging spectrometer 802 can be comprised of a concentric hemispherical analyzer 803, with an output lens 804, and electron image detector means 805.

As will be apparent to someone ordinarily skilled in the art a wide range of modifications can be made to the physical arrangement present herein to produce better or worse results. The example of the electron optical arrangement described herein uses a principle that applies over a range of physical implementations.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

I claim:

1. A photoelectron imaging apparatus comprising:
(a) a vector potential field of substantially uniform curl,
(b) a sample immersed in said vector potential field,
(c) a source of photons for illuminating said sample and producing photoelectrons,
(d) an substantially electron transparent field reducing means for substantially reducing the magnitude of said vector potential field over a substantially short distance,
whereby an angular image is formed by said photoelectrons emitted by said source of photons illuminating said sample.

2. The photoelectron imaging apparatus of claim 1 wherein said vector potential field is produced by a current carrying solenoid.

3. The photoelectron imaging apparatus of claim 1 wherein said electron transparent field reducing means comprises a ferromagnetic enclosure with an aperture.

4. The photoelectron imaging apparatus of claim 1 wherein said vector potential field is produced by a ferromagnetic assembly comprising a magnet.

5. A method of forming a photoelectron image comprising:
(a) providing a vector potential field for a spatial reference,
(b) immersing a sample in said vector potential field,
(c) providing a source of photons,
(d) illuminating said sample with said source of photons for the production of photoelectrons from said sample,
(e) providing a first means for field reduction for substantially reducing the magnitude of said vector field over a substantially short distance and permitting the exit of said photoelectrons from said vector potential field,
(f) providing a second means to image said photoelectrons,
whereby an image is formed by said photoelectrons emitted from said sample surface.

6. The photoelectron imaging apparatus of claim 5 wherein said vector potential field is produced by a current carrying solenoid.

7. The photoelectron imaging apparatus of claim 5 wherein said electron transparent field reducing means is an aperture in a ferromagnetic enclosure.

8. The photoelectron imaging apparatus of claim 5 wherein said vector potential field is produced by a ferromagnetic assembly comprising a magnet.

9. The photoelectron imaging apparatus of claim 5 wherein said second means to image said photoelectrons comprises a plurality of grids and a phosphor.

10. The photoelectron imaging apparatus of claim 5 wherein said second means to image said photoelectrons comprises a converging lens and an imaging spectrometer.

11. The photoelectron imaging apparatus of claim 9 wherein said imaging spectrometer comprises a concentric hemispherical analyzer.

12. A photoelectron imaging apparatus comprising:
(a) a vector potential field of substantially uniform curl for producing a spatial reference,
(b) a sample immersed in said vector potential field,
(c) a source of photons for illuminating said sample and producing photoelectrons,
(d) an substantially electron transparent field reducing means for substantially reducing the magnitude of said vector potential field over a substantially short distance, and permitting the exit of said photoelectrons from said vector potential field,
(f) providing an imaging means to image said photoelectrons,
whereby an image is formed by said photoelectrons emitted from said sample surface.

13. The photoelectron imaging apparatus of claim 12 wherein said vector potential field is produced by a current carrying solenoid.

14. The photoelectron imaging apparatus of claim 12 wherein said electron transparent field reducing means is an aperture in a ferromagnetic enclosure.

15. The photoelectron imaging apparatus of claim 12 wherein said vector potential field is produced by a ferromagnetic assembly comprising a magnet.

16. The photoelectron imaging apparatus of claim 12 wherein said second means to image said photoelectrons comprises a plurality of grids and a phosphor.

17. The photoelectron imaging apparatus of claim 12 wherein said second means to image said photoelectrons comprises a converging lens and an imaging spectrometer.

18. The photoelectron imaging apparatus of claim 17 wherein said imaging spectrometer comprises a concentric hemispherical analyzer.

19. The photoelectron imaging apparatus of claim 12 that further comprises an ambient pressure reaction cell.
